(19) United States
(12) Patent Application Publication
(10) Pub. No.: US 2015/0033468 A1
(43) Pub. Date: Feb. 5, 2015

(54) INSECT-DISCOURAGING DRAIN DEVICE

(71) Applicant: BLACKHAWK TOOL & MACHINE, LLC (FKA BLACKHAWK MACHINE LLC), Perrysburg, OH (US)

(72) Inventor: Michael A. Sapara, Oregon, OH (US)

(73) Assignee: BLACKHAWK MACHINE LLC, Oregon, OH (US)

(21) Appl. No.: 13/928,303

(22) Filed: Jun. 26, 2013

Related U.S. Application Data
(63) Continuation of application No. 13/746,985, filed on Jan. 22, 2013.

(51) Int. Cl. A01N 25/34; E03C 1/18

(52) U.S. Cl. CPC A01N 25/34; E03C 1/18
USPC 4/638; 424/405

(57) ABSTRACT

An insect-discouraging device (30) for installation at various sites in a sink system to periodically release an insect-discouraging material (31) without human participation. The insect-discouraging material (31) may comprise formulated chemicals, biological pesticides, viral agents, and/or micro-organisms. Such insect-discouragers are usually available in a variety of forms (e.g., powder, granules, liquid, etc.) whereby a format can be chosen that is compatible with the selected device design and the intended venue.

### RELATED APPLICATION

This application claims priority under 35 USC §120 to, and is a continuation application of, U.S. patent application Ser. No. 13/746,985 filed on Jan. 22, 2013 which was a continuation application of, International Patent Application No. PCT/US2011/048705 filed on Aug. 22, 2011 and claiming priority to U.S. Provisional Patent Application No. 61/375,399 filed on Aug. 20, 2010. The entire disclosures of these applications are hereby incorporated by reference.

### BACKGROUND

A commercial sink system, such as is used in a restaurant setting, have a propensity to create a rich feeding and breeding ground for insects such as fruit flies. This problem has traditionally been addressed by kitchen personnel (e.g., a dishwasher or other behind-the-scenes worker) being assigned the daily task of pouring a chemical gel in the floor drain. When this protocol is ineffective (or more commonly, not followed) insects inevitably invade the premise and make an enjoyable dining experience impossible. An establishment often has no choice but to shut its doors and set off a “bug bomb” producing a pesticide fog that permeates everywhere. This results in lost revenue during the restaurant's downtime and also an expensive post-bomb cleanup operation.

### SUMMARY

A device is provided that can automatically (i.e., without continuous human interaction) dispense an insect-discouraging material over a period of time in a sink system. This automatic insect-discouraging dispenser can keep a restaurant insect-free and open for business, even with unreliable kitchen personnel. And the device can be constructed for installation in most existing commercial sink systems, whereby it requires little capital investment.

### DRAWINGS

FIG. 1 is a schematic view of a commercial sink system.

FIGS. 2A-2C, FIGS. 3A-3C, FIGS. 4A-4C, FIGS. 5A-5C, FIGS. 6A-6C, FIGS. 7A-7B, FIGS. 8A-8B, FIGS. 9A-9B, FIGS. 10A-10B, FIGS. 11A-11B, and FIGS. 12A-12B are each views of different versions of the insect-discouraging device.

### DESCRIPTION

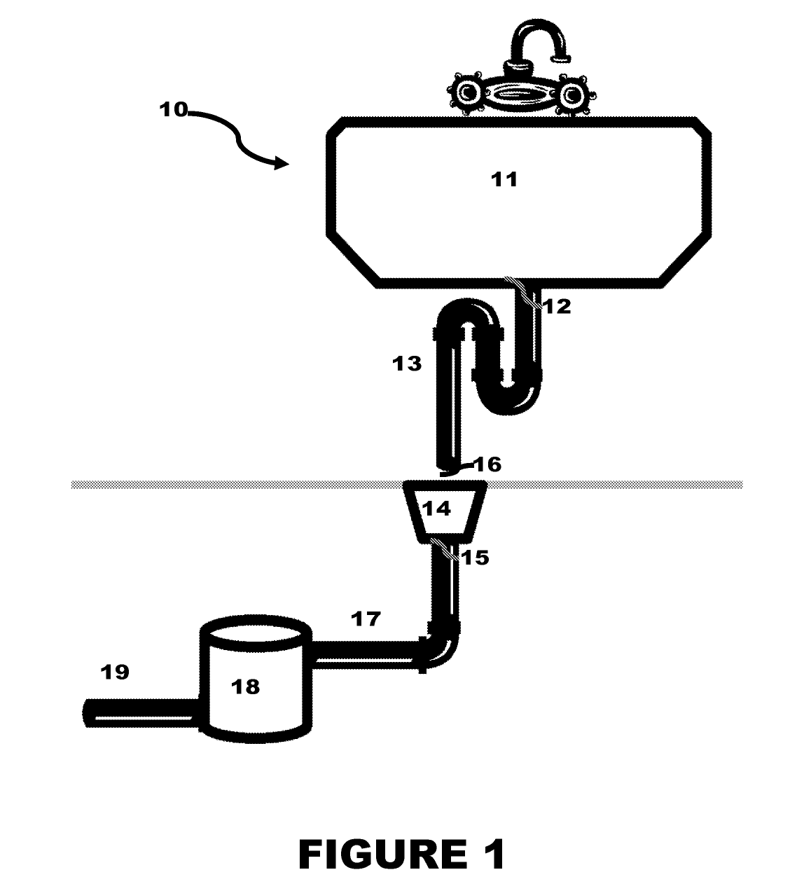

Referring now to the drawings, and initially to FIG. 1, a sink system 10 is shown. The system 10 comprises a basin 11 with a faucet positioned to supply water thereto. The basin 11 has a bottom outlet 12 and a pipe 13 extending downward from this outlet 12. A crock 14 (having an outlet 15) is situated below the exit end of the pipe 13 so as to provide an air gap 16 therebetween. A pipe 17 can extend from the crock's outlet 15 to an entrance of a grease-trap container 18 and a pipe 19 can connect the container's exit to a sewer line.

The sink basin 11 can be, for example, located in a food-preparation station (whereat fruits, vegetables, and other food are rinsed), a dish-cleaning station (whereat edible remains are removed from plates, pots, pans, and other containers), a drink-service station (whereat beverage residue is poured from glasses), a washing station (whereat hands are cleansed), or any other station. In any event, water drained from the basin 11 flows through the pipe 13, into the crock 14, through the pipe 17 and into the grease-trap container 18. The crock 14 and/or the grease-trap container 18 frequently create a rich breeding ground for fruit flies and/or other insects.

As is best seen by referring generally to the rest of the Figures, an insect-discouraging device 30 can be installed at various sites in the sink system 10. In each or any case, the device 30 is designed to periodically release an insect-discouraging material 31 without human participation. The insect-discouraging material 31 may comprise formulated chemicals, biological pesticides, viral agents, and/or micro-organisms. Such insect-discouragers are usually available in a variety of forms (e.g., powder, granules, liquid, etc.) whereby a format can be chosen that is compatible with the selected device design and the intended venue.

The insect-discouraging material 31 can be included in a composition containing other ingredients such as diluents, adjuvants, dyes, alcohols, acetone, ketones, oils, surfactants, water, emulsifiers, film-forming agents, compatibility agents, wetting agents, salt, natural or synthetic polymers, hydrocolloids, buoyancy modifiers, ultraviolet absorbers, photo-protecting agents, suspending agents, elastomers, penetrants, deflocculating agents, dispersing agents, stabilizing agents, antifoaming agents, sticking agents, solvents, co-solvents, catalysts, and/or synergists.

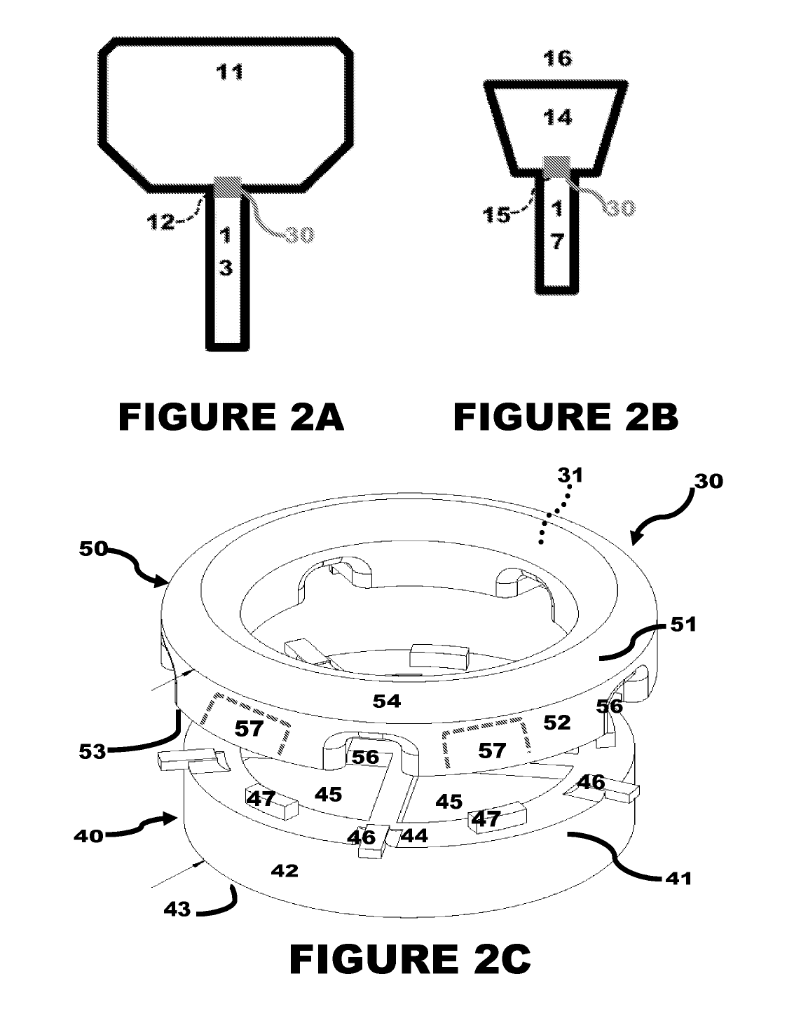

While the insect-discouraging material 31 may comprise pesticides, this need not be the case. In fact, the device 30 and/or the dispenser 50 can be characterized by the absence of pesticides in the insect-discouraging material 31. The insect-discouraging device 30 shown in FIGS. 2A-2C is adapted for installation in the outlet drain 12 of the basin 11 or in the outlet drain 15 of the crock 14. The device 30 includes a mounting part 40, that can be a permanent and/or insoluble part, and a dispenser 50, which can be a replaceable and/or soluble part. The insect-discouraging material 31 is incorporated into the dispenser 30 so that, as it dissolves, the material 31 is dispensed to the sink system 10.

The mounting part 40 shown in the second set of drawings comprises an annular body 41 having cylindrical sidewall 42 with a flat floor 43 and a level ceiling 44. The outer diameter of the annular body 41 and/or the cylindrical sidewall 42 can be sized for snug insertion into the crock outlet 15. The part 40 can include straining passageways 45 and mating members (e.g., planks 46 and podiums 47) for mating with the dispenser 50.

The dispenser 50 shown in FIG. 2C is configured to sit on the ceiling 44 of mounting part 40 and mate therewith. The dispenser 50 can comprise an annular body 51 having cylindrical sidewall 52 with a floor 53 and a ceiling 54. The cylindrical sidewall 52 has an outer diameter corresponding to that of the sidewall 42 of the mounting part 40 for alignment therewith. The dispenser 50 can include mating members (e.g., corridors 56 and pockets 57) for mating with the mounting part 40.

During initial installation of the insect-discouraging device 30 shown in FIG. 2A-2C, the mounting part 40 is inserted into the drain outlet 15 of the crock 14. The parts 40/50 are mated together by vertically aligning the dispensing part 50 with the mounting part 40 and turning it to mate the relevant members. The parts 40/50 can be mated prior to or after insertion of the mounting part 40 is into the drain outlet 15.

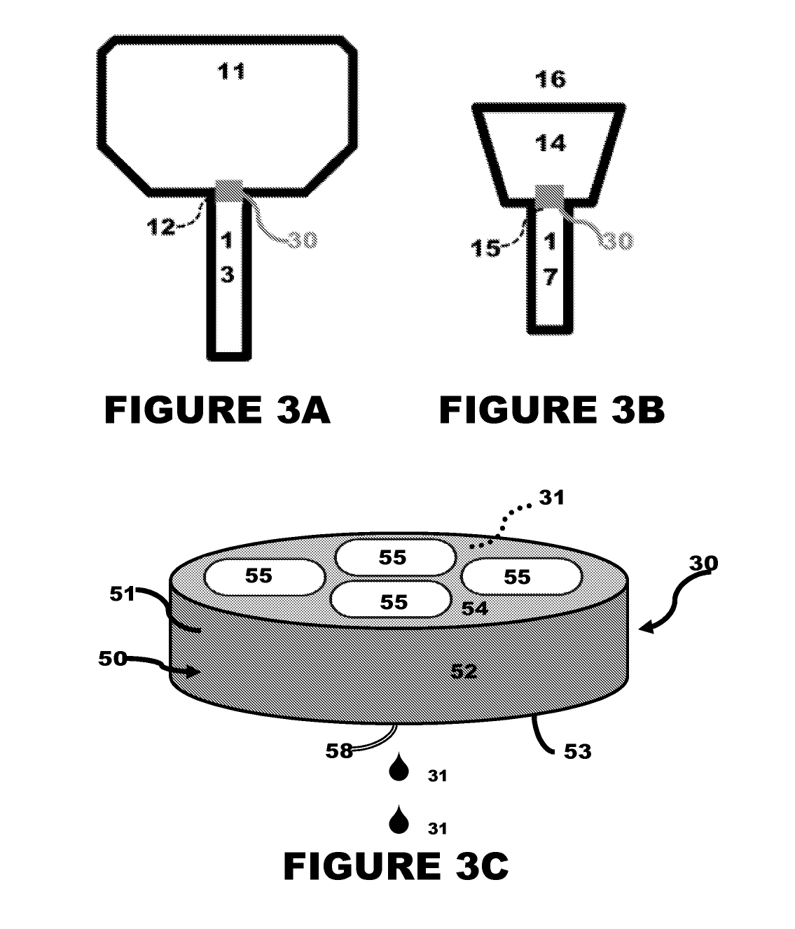

The insect-discouraging device 30 shown in FIGS. 3A-3C is adapted for installation in the outlet drain 12 of the basin 11 or in the outlet drain 15 of the crock 14. The device 30 comprises a dispenser 50 having a body 51 containing the insect-discouraging material 31. The body 51 comprises a cylindrical sidewall 52, a circular floor 53, and a circular ceiling 54. The cylindrical sidewall 52 is sized for snug insertion in the drain outlet 12/15, whereby it also functions as a mounting part. Straining passageways 55 extend through the body 51 whereby the dispenser 50 can substitute for a standard straining cup. The body 51 further includes a dispensing port 58 (e.g., on its floor 53) through which the insect-discouraging material is dispensed. Depending upon the intended circumstances, the body 51 may be openable for refilling, or it may be sealed closed so as to impede refilling.

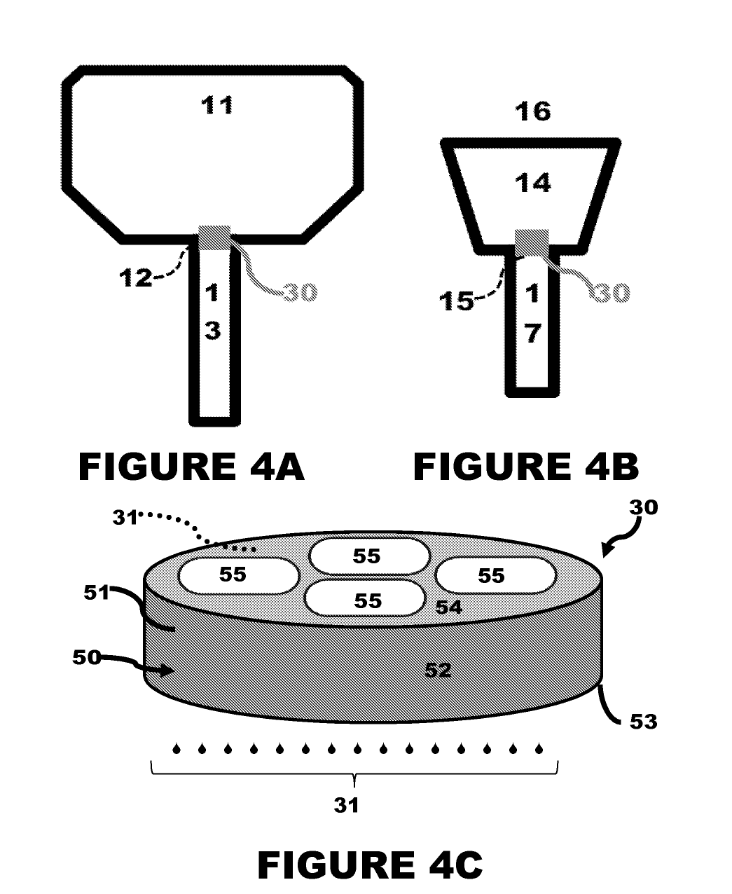

The insect-discouraging device 30 shown in FIGS. 4A-4C is similar in some aspects to that shown in FIGS. 3A-3C. It is adapted for installation in the outlet drain 12 or the outlet drain 15, and it comprises a dispenser 50 that also functions as a mounting part. In this embodiment, however, the body 51 is soluble and the insect-discouraging material 31 is integrated therein. There is no need for a dispensing port 58, as the material 31 is dispensed as the body 51 dissolves. If the device 30 is to substitute for a standard straining cup, it can be provided with a non-soluble skeleton that remains after body dissolution.

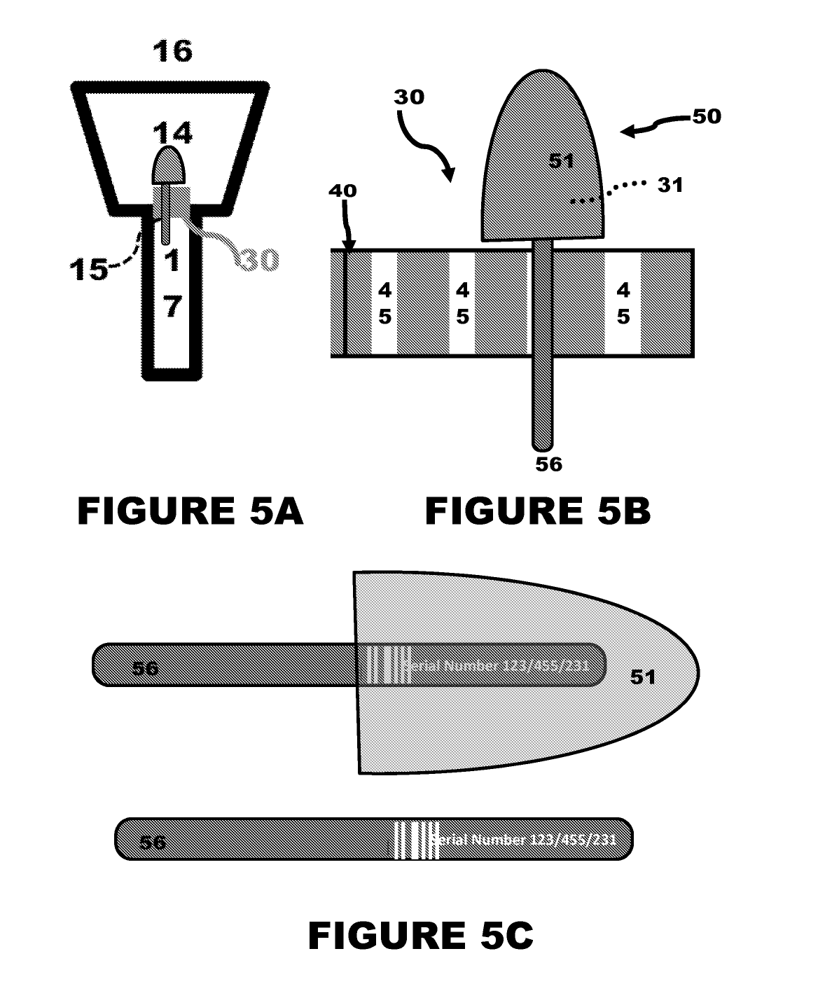

The insect-discouraging device shown in FIG. 5A-5B comprises a body 51 and an attachment member 56 connected thereto (e.g., molded therearound). The body 51 incorporates the insect-discouraging material 31 and it can be adapted to dissolve at a controlled rate upon contact with water. The preferably insoluble attachment member 56 is sized and shaped for insertion into a strainer passageway 45 in a mounting part 40. For example, the member 56 can have a post-like profile. In this embodiment, the mounting part 40 can be a standard and/or pre-existing strain cup for the sink. In the device 30 shown in FIGS. 5A-5B, the attachment member 56 can be a different color than the body 51 so as to visually convey when it is time for a replacement dispenser. This visual indication technique can be used in any device or dispenser design wherein the body 51 dissolves with use, but a permanent member remains after depletion. Additionally or alternatively, a permanent member (e.g., the attachment member 56) can contain record-keeping data so as to track a facility's use of the devices 30. This data can become visible and/or readable only after dissolution of the body 51, whereby it can be used to verify/validate insect-discouraging procedures.

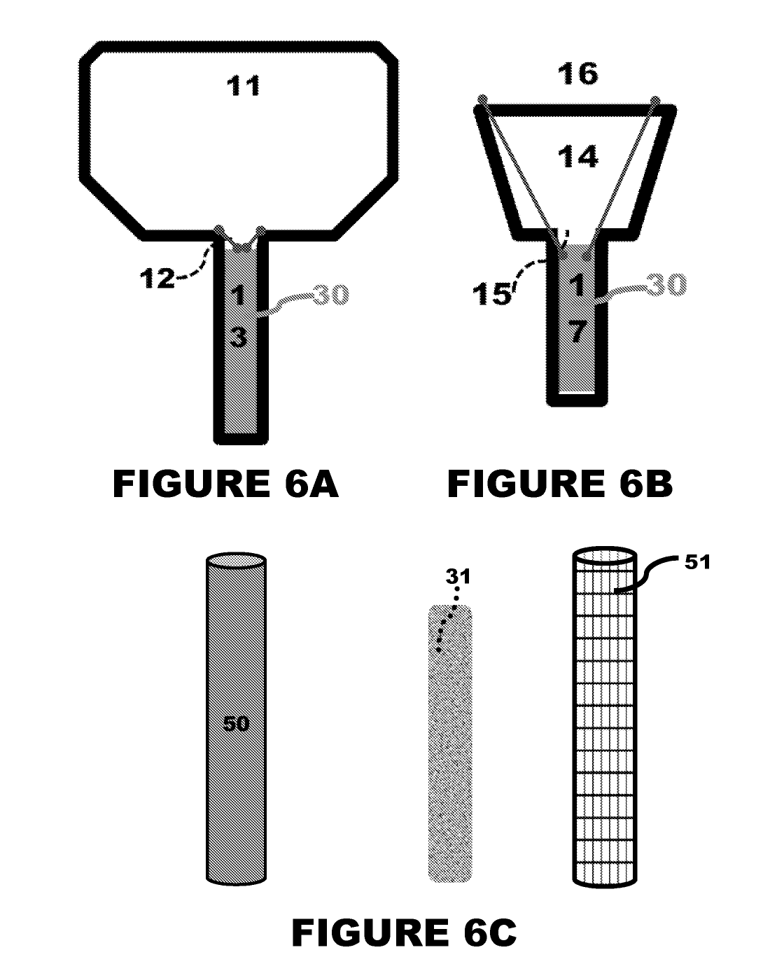

The dispenser 50 of the device 30 shown in FIGS. 6A-6B is adapted for insertion into the drain pipe 13 or the drain pipe 17. The body 51 has a sausage-like shape and is preferably flexible to accommodate pipe elbows and other plumbing turns. The insect-discouraging material 31 can be non-solid and/or a non-rigid (e.g., a liquid, a powder, or a mass of small particles) and the body 51 can be made of a mesh fabric to permit the insect-discouraging material 31 to dispense therethrough. The body 51 can be anchored to a mounting part in the associated drain outlet 12/15. With particular reference to drain pipe 17, the body 51 can be anchored to the top edge of the crock 14, and the body 51 can extend upwardly thereinto.

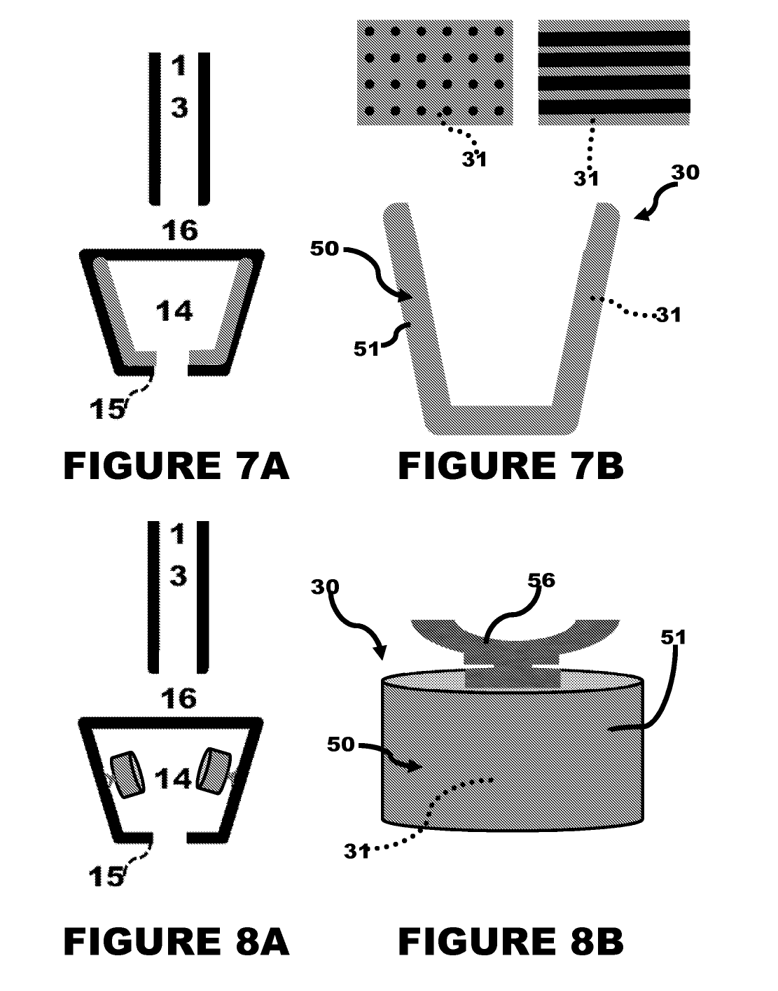

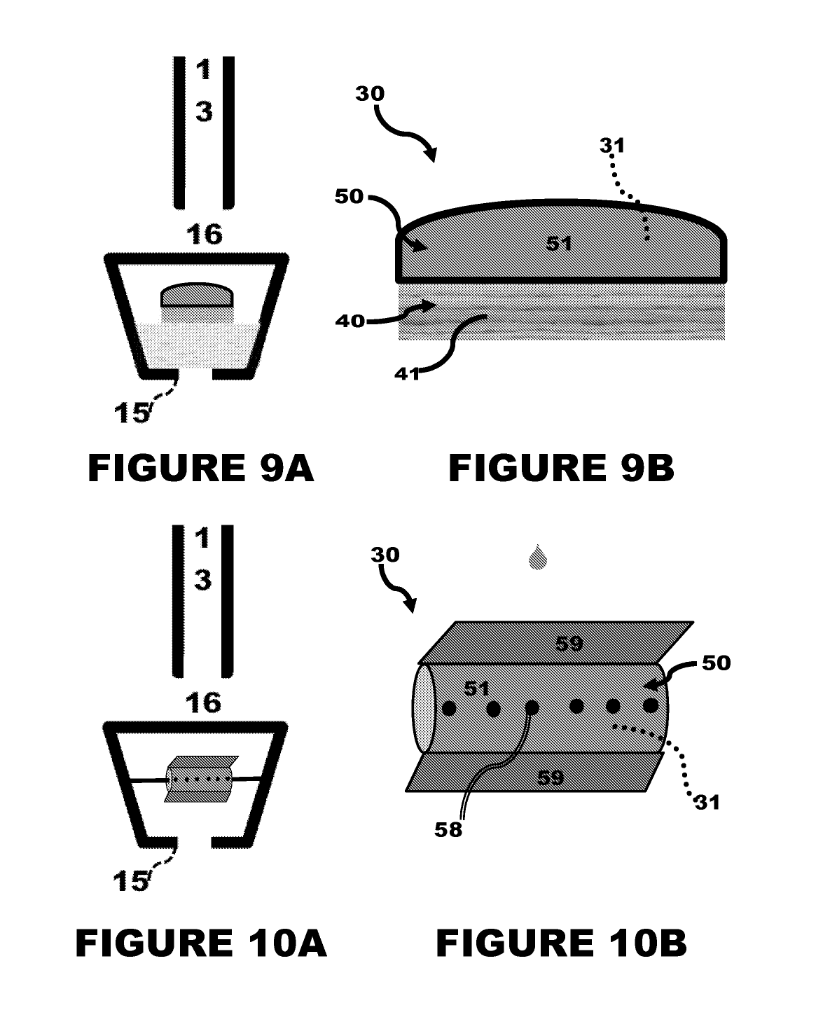

In the insect-discouraging devices 30 shown in FIGS. 7A-7B, FIGS. 8A-8B, and FIGS. 9A-9B, the dispensers 50 are adapted to reside within the crock 14 and their bodies 51 each have a dissolvable insect-discouraging material 31 incorporated therein. In the device 30 shown in FIGS. 7A-7B, the dispenser 50 comprises a cup-shaped body 51 sized and shaped to line the inside surface of the crock 14. In the device 30 shown in FIGS. 8A-8B, the dispenser 50 comprises a disk-shaped body 51 attached to the interior sides of the crock 40 via removable attachment members 56 (e.g., suction cups). And in the device 30 shown in FIGS. 9A-9B, the dispenser 50 comprises a disk-shaped body 51 attached to a floating mounting part 40.

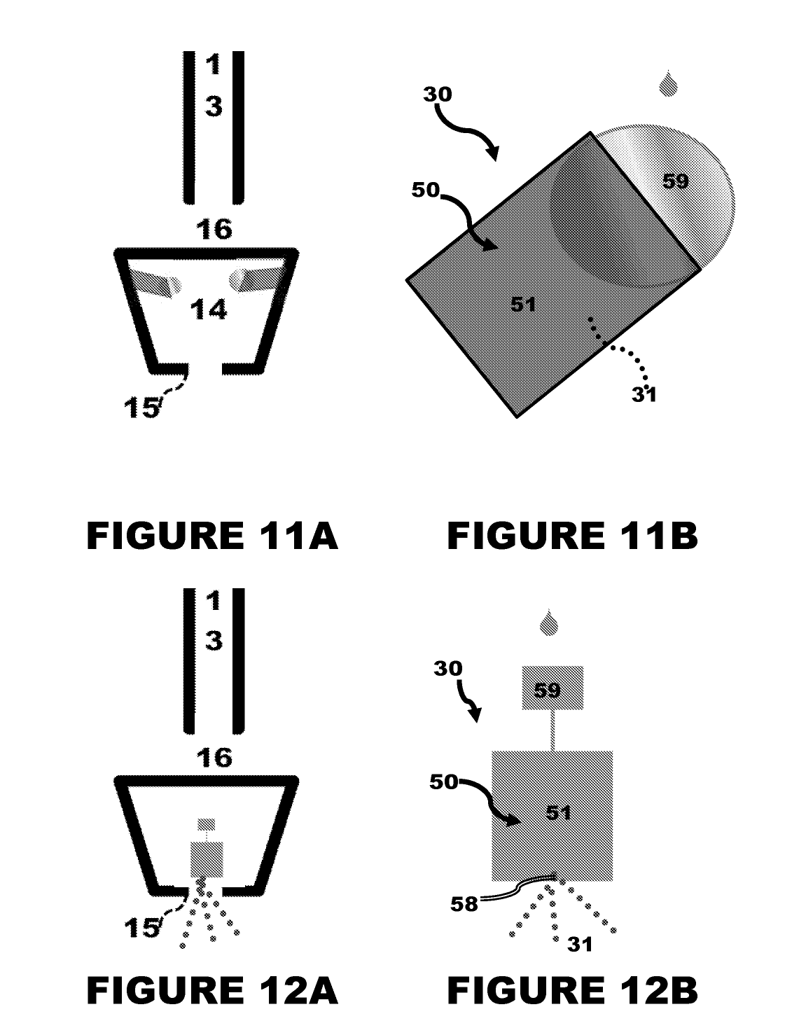

In the insect-discouraging devices 30 shown in FIGS. 10A-10B, FIGS. 11A-11B, and FIGS. 12A-12B, the dispensers 50 are also adapted to reside within the crock 14 and their bodies 51 contain the insect-discouraging material 31 therein. And these dispensers are triggered when water is drained into the crock 14. In the device 30 shown in FIGS. 10A-10B, water-contacting paddles 59 rotate the body 51 so that its dispensing ports 58 face downward and the insect-discouraging material 31 is dispensed therefrom. In the device 30 shown in FIGS. 11A-11B, a ball 59 rotates upon water contact to collect and then release the insect-discouraging material 31. In the device 30 shown in FIGS. 12A-12B, a pump head 59 is pushed upon water contact to spray or otherwise dispense insect-discouraging material 31.

One may now appreciate that the device 30 passively and automatically provides insect-discouraging protection for the sink system 10. Although the sink system 10, the device 30, the mounting part 40, and/or the dispenser 50 have been shown and described with respect to a certain embodiment or embodiments, it is obvious that equivalent alterations and modifications will occur to others skilled in the art upon the reading and understanding of this specification and the annexed drawings.

1. An insect-discouraging dispenser comprising:
an insect-discouraging material; and
a body made of a mesh fabric through which the insect-discouraging material dispenses therethrough;

2. An insect-discouraging dispenser as set forth in claim 1, wherein the insect-discouraging material comprises a pesticide.

3. An insect-discouraging dispenser as set forth in claim 1, wherein the insect-discouraging material is characterized by the absence of a pesticide.

4. An insect-discouraging dispenser as set forth in claim 1, wherein the insect-discouraging material is formulated to provide an effective dosage for a period of time of at least one week.

5. An insect-discouraging dispenser as set forth in claim 4, wherein the insect-discouraging material is formulated to provide an effective dosage for a period of time of at least two weeks.

6. An insect-discouraging dispenser as set forth in claim 5, wherein the insect-discouraging material is formulated to provide an effective dosage for a period of time of at least one month.

7. An insect-discouraging dispenser as set forth in claim 1, wherein the insect-discouraging material is in powder form.

8. An insect-discouraging dispenser as set forth in claim 1, wherein the insect-discouraging material is in granule form.

9. An insect-discouraging dispenser as set forth in claim 1, wherein the insect-discouraging material is in liquid form.

10. A sink system comprising a basin, an outlet, a pipe extending from the outlet, a crock situated adjacent the outlet end of the pipe, and a dispenser as set forth in claim 1 installed in the basin.

11. A sink system as set forth in claim 10, wherein the basin is in a drink-service station whereat beverage residue is poured from glasses.
